(19) United States
(12) Patent Application Publication
(10) Pub. No.: US 2018/0336463 A1
(43) Pub. Date: Nov. 22, 2018

(54) SYSTEMS AND METHODS FOR DOMAIN-SPECIFIC OBSCURED DATA TRANSPORT

(71) Applicant: General Electric Company, Schenectady, NY (US)

(72) Inventor: Joshua Simon Bloom, Berkeley, CA (US)

(21) Appl. No.: 15/816,899

(22) Filed: Nov. 17, 2017

Related U.S. Application Data
(60) Provisional application No. 62/508,246, filed on May 18, 2017.

(51) Int. Cl. G06N 3/08

(52) U.S. Cl. CPC G06N 3/08

(57) ABSTRACT

Various embodiments provide systems and methods that implement domain-specific obfuscating of data when processing the data through machine learning (ML), which can secure and preserve privacy of information contained within the data. For instance, various embodiments provide domain-specific techniques for obscuring, and possibly compressing, data. Additionally, various embodiments provide for remote inference using domain-specific techniques for obscuring, and possibly compressing, data for transport.

### CROSS-REFERENCE TO RELATED APPLICATION

This application claims priority to and the benefit of U.S. Provisional Patent Application No. 62/508,246, filed on May 18, 2017, which is incorporated herein by reference in its entirety.

### TECHNICAL FIELD

The present application relates to data encoding and decoding and, more particularly, domain-specific data encoding and decoding for obfuscating and, additionally, for compressing data, which can be useful when transporting data over a communications network.

### BACKGROUND

Data security is a crucial element of today's products and services, particularly when data is being communicated over a communications network, such as the Internet, which is commonplace in cloud-based computing services. Data security not only secures sensitive information from unauthorized access, but also preserves the privacy of individuals to whom the information may relate (e.g., medical records, financial records, etc.). With the emergence of machine learning (ML) and its use in client-server computing services, as well as big data processing platforms that analyse data from many different sources, the security and privacy of information being processed through and produced by various ML techniques (e.g., ML models) remains important. Conventional technologies often use forms of encryption, such encryption based on public and private keys, to securely communicate data between computing devices. Additionally, to reduce usage of data communication bandwidth, conventional technologies often use compression techniques to reduce the data to be communicated between computing devices.

### BRIEF DESCRIPTION OF THE DRAWINGS

Some embodiments are illustrated by way of example and not limitation in the figures of the accompanying drawings.

FIG. 1 is a block diagram illustrating an example networked system including an inference machine learning (ML) model component and an example remote device including a remote machine learning (ML) model component, according to some embodiments of the present disclosure.

FIG. 2 is a block diagram illustrating an example system including an inference machine learning (ML) model component and a remote machine learning (ML) model component, according to some embodiments of the present disclosure.

FIG. 3 is a flow chart illustrating an example method for an autoencoder model, in accordance with some embodiments of the present disclosure.

FIG. 4 is a flow chart illustrating an example method for a machine learning (ML) model, in accordance with some embodiments of the present disclosure.

FIG. 5 is a diagram illustrating performance of an example method on an example autoencoder machine learning (ML) model, in accordance with some embodiments of the present disclosure.

FIG. 6 is a diagram illustrating performance of an example method on an example machine learning (ML) model comprising a neural network, in accordance with some embodiments of the present disclosure.

FIGS. 7-10 are flow charts illustrating example methods for a machine learning (ML) model, in accordance with some embodiments of the present disclosure.

FIGS. 11-12 are flow charts illustrating example methods for a machine learning (ML) model, in accordance with some embodiments of the present disclosure.

FIG. 13 is a block diagram illustrating an example software architecture, which may be used in conjunction with various hardware architectures herein described, according to various embodiments of the present disclosure.

FIG. 14 is a block diagram illustrating components of an example machine able to read instructions from a machine storage medium and perform any one or more of the methodologies discussed herein, according to various embodiments of the present disclosure.

### DETAILED DESCRIPTION

Various embodiments provide systems and methods that implement domain-specific obfuscation of data when processing the data through machine learning (ML) process, which can secure and preserve privacy of information contained within the data. In particular, various embodiments provide domain-specific techniques for obscuring, and possibly compressing, data. Additionally, various embodiments provide for remote inference using domain-specific techniques for obscuring, and possibly compressing, data for transport.

Various embodiments can obviate the need for encrypting, and may further obviate the need for compressing, large amounts of data when such data is being securely communicating. For instance, some embodiments may encode input data to simultaneously obfuscate and compress the input data, such large amount of confidential data, on one computing device before the input data is communicated to another computing device over a communications network. Upon communication of the resulting encoded data, the other computing device can decode, and thereby un-obfuscate and decompress, the encoded data on the other computing device. The resulting decoded data on the other computing device may represent a reconstruction of the input data encoded at the first computing device. In this way, some embodiments permit communication of highly compressed, encoded data from a computing device to another computing device in such a way that if that encoded data were intercepted, the original input could not be reproduced.

Furthermore, some embodiments can prevent an attacker (e.g., malicious hacker) on the sending computing device to do an inference based on the input data without encoding and sending the encoded data to another computing device to perform the inference. This can secure usage of a ML process.

In regard to the domain-specific techniques for obscuring data, domain-specific data encoding and decoding that is learned during the course of an ML training process can be used to obfuscate, and further to compress, data, which may then be transported over a communications channel (e.g., over a communications network). Through some embodiments, a computing device can send (e.g., from a remote, edge computing device to a server computing device) data encoded by a trained domain-specific encoder such that if the encoded data were intercepted, the original data could not be reproduced without a trained domain-specific decoder. In this way, the encoded data produced by the trained domain-specific encoder can be obfuscated, and remain that way until it is decoded by the trained domain-specific decoder. Additionally, the encoded data produced by the trained domain-specific encoder may be compressed in comparison to the original data, which can also be beneficial for data transport.

For some embodiments, an auto-encoding process, such as one implemented by an autoencoder model in ML contexts, is split into its encoding and decoding processing components after the auto-encoding process (e.g., autoencoder network) has been trained on a training data set relating to a specific domain, such as medical images that can include magnetic resonance imaging (MRI) images. For some embodiments, the encoder implements an encoder neural network and the decoder implements a decoder neural network. The split components can be placed at different computing devices; for example, a sending computing device could receive the encoding component and a remote receiving computing device could receive the decoding component. Thus, the prediction pipeline of the auto-encoding process can be split such that the prediction component need only receive the encoded data to generate prediction data. For instance: a sending computing device, such as an edge computing device, can possess the encoding component; a remote computing device, such as a server supporting a cloud service, can possess the decoding component; the sending computing device can encode original, domain-specific data (e.g., an MRI image), using the encoding component, and send the encoded data to the remote computing device, such as over a communications network; and the remote computing device can decode the encoded data, using the decoding component, to reconstruct a representation of the original data. Based on the decoded data, the remote computing device can generate prediction data (e.g., using a neural network classifier), and may return the prediction data to the sending computing device. The encoded data may be encrypted, such as by a machine-specific encryption key, before being communicated to a receiving computing device. Additionally, the encoded data may be sent with metadata relating to the encoded data, such as information regarding the encoding component that generated the encoded data, which can include versioning information regarding the architecture of the encoding component or the original autoencoder model.

The decoded data may comprise a smaller, reconstructed (e.g., an approximate reconstruction), and faithful representation of the original data (e.g., in view of a tunable loss metric of the autoencoder) encoded by the encoding component, upon which a prediction computation may be better performed than on the original data. For example, the decoded data may comprise a smaller representation (e.g., array of 300 real-number values) of original MRI image data (e.g., 1 k×1 k×50 image data), which a ML classifier can then more quickly process for training or prediction purposes. This ML classifier may be one that is trained to predict whether an MRI image shows a particular ailment, such as a cancerous tumor. The compression achieved by the auto-encoding process can be configured during training by way of a loss function. The amount of compression may anti-correlate with the loss. An embodiment may be implemented by way of a variety of different autoencoder frameworks including, for example, ones based on TensorFlow™ or CNTK™.

Subsequent to training, splitting, and distributing the auto-encoding process to separate computing devices, updates may involve training the auto-encoding process at one computing device (e.g., a model computing device that builds, trains, and updates the autoencoder), and sending an updated encoder (e.g., an entire encoder network) or, alternatively, metadata (e.g., changes to weight data) representing the updates to the encoder to computing devices (e.g., remote, edge computing devices) possessing an older version of the encoder. The metadata can save the time and bandwidth of sending the entire encoder to the computing devices possessing an older version of the encoder. Whether an entire network or metadata is sent during an update may depend on the nature of the change. For instance, the entire encoder network will be transmitted in response to an update involving a topology change to the encoder neural network (e.g., a change from a 12-layer network to a 15-layer network) and, alternatively, metadata will be transmitted in response to an update to weight data of one or more layers of the encoder neural network.

In regard to remote inference using domain-specific techniques for obscuring data for transport, a (learned) machine learning (ML) model, such as a convolutional neural network (CNN) or the like, is split into a plurality of components (e.g., two components) and the components are distributed to multiple computing devices. The ML model may comprise a ML algorithm. The ML model may be trained on a corpus of training data (e.g., images, text files, video, time-series data, etc.) relating to a specific domain (e.g., medical predictions), the trained ML model can be split into the plurality of components (e.g., phase components), and individual components can be distributed to individual computing devices (e.g., a sending computing device, a remote computing device, and any intervening computing devices). In this way, without access to the full ML model, no one of the distributed computing devices, or other computing device, can make use of the information being transported (e.g., reconstruct the original data). Additionally, no attack on an edge computing device can result in reconstruction of the full output of the ML model.

For instance: a trained ML model (e.g., a CNN) can be split into a phase I component (e.g., comprising a series of initial layers of the CNN) and a phase II component (e.g., comprising a series of end layers of the CNN); a sending computing device (e.g., an edge computing device) can possess the phase I component; a remote computing device (e.g., a server supporting a cloud service) can possess the phase II component; the sending computing device can encode original, domain-specific data (e.g., an MRI image), using the phase I component, and send the encoded data to the remote computing device (e.g., over a communications network); and the remote computing device can further encode the received encoded data, using the phase II component, to produce result data, which can represent an inference made by the ML model (e.g., a classification, regression, or prediction).

In another instance: a trained ML model, such as a CNN, can be split into: a phase I component, which may comprise a series of initial layers of the CNN; a phase II component, which may comprise a series of intervening layers of the CNN; and a phase III component, which may comprise a series of end layers of the CNN. A sending computing device (e.g., an edge computing device) can possess the phase I and phase III components, and a remote computing device (e.g., a server supporting a cloud service) can possess the phase II component. The sending computing device can encode original, domain-specific data (e.g., an MRI image), using the phase I component, and send the encoded data to the remote computing device (e.g., over a communications network). The remote computing device can further encode the received encoded data, using the phase II component, and send the resulting intervening encoded data to the sending computing device. The sending computing device can further encode the received, intervening encoded data to produce result data, which can represent an inference made by the ML model (e.g., a classification, regression, or prediction).

Reference will now be made in detail to embodiments of the present disclosure, examples of which are illustrated in the appended drawings. The present disclosure may, however, be embodied in many different forms and should not be construed as being limited to the embodiments set forth herein.

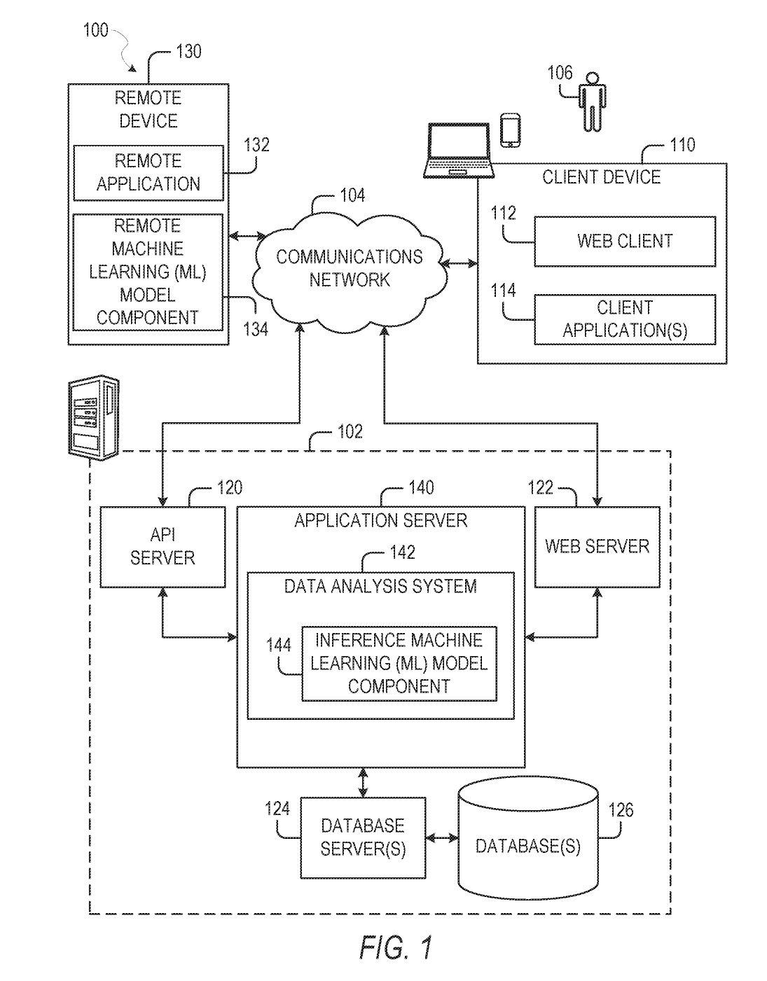

FIG. 1 is a block diagram illustrating an example networked system 102 including an inference machine learning (ML) model component 144 and an example remote device 130 including a remote machine learning (ML) model component 134, according to some embodiments. According to some embodiments, the inference ML model component 144 and the remote ML model component 134 are generated, from a ML model, by a system or method described herein. For instance, the remote ML model component 134 may comprise an encoder neural network that generates encoded data based on input data, and the inference ML model component 144 may comprise a decoder neural network that generates decoded data based on encoded data. In another instance, the remote ML model component 134 may comprise an initial portion (e.g., half) of a neural network that generates intermediate neural network output data based on input data, and the inference ML model component 144 may comprise a final portion (e.g., half) of a neural network that generates result data based on intermediate neural network output data.

With reference to FIG. 1, an embodiment of a high-level client-server-based network architecture 100 is shown. As shown, the network architecture 100 includes the networked system 102, a client device 110, one or more remote devices 130, and a communications network 104 facilitating data communication therebetween. The networked system 102 provides server-side data analysis functionality, via the communications network 104, to one or more client devices 110. FIG. 1 illustrates, for example, a web client 112, such as a web browser, and a client application 114 executing on the client device 110.

As also shown, the networked system 102 includes a data analysis system 142 comprising the inference ML model component 144. The data analysis system 142 may use one or more machine learning (ML) algorithms or models in performing data analysis operations, which may relate to analyzing data from industrial devices, such as generators, wind turbines, medical devices, jet engines, and locomotives. In this way, the networked system 102 can form an industrial device data analysis software platform. This industrial device data analysis software platform can include a collection of software services and software development tools, which enable a user (e.g., an industrial customer) to use, or develop and use, applications for optimizing industrial business processes with respect to industrial devices.

In FIG. 1, the remote device 130 may represent an industrial device that includes a remote application 132 to collect data from the remote device 130, such as sensor data, diagnostic data, or performance data. The collected data may comprise event logs, error logs, time-series data, and the like. The collected data may be used as input data to the remote ML model component 134, which can cause the remote ML model component 134 to generate encoded data or intermediate neural network output data. Subsequently, the encoded data or intermediate neural network output data can be provided to the data analysis system 142 for additional analysis, such as generating an inference or prediction based on the input data collected from the remote device 130. Prior to being provided to the data analysis system 142, the encoded data/intermediate neural network output data may be encrypted, such as by a machine-specific encryption key. Additionally, the encoded data/intermediate neural network output data may be provided with metadata relating to the encoded data/intermediate neural network output data, such as information regarding the remote ML model component 134 that generated the encoded data/intermediate neural network output data, which can include versioning information regarding the architecture of the remote ML model component 134.

According to some embodiments, the data analysis system 142 can receive encoded data or intermediate neural network output data from the remote device 130, which may be produced at the remote device 130 by the remote ML model component 134. The data analysis system 142 can use the inference ML model component 144 to generate result data based on the input data processed by the remote ML model component 134 at the remote device 130. The result data may comprise, or assist in generation of, inference or prediction data based on the input data, which the data analysis system 142 may utilize to generate analysis regarding the remote device 130, such as analysis relating to future service, maintenance, or failure of the remote device 130.

The client device 110 may comprise, but is not limited to, a mobile phone, desktop computer, laptop, portable digital assistant (PDA), smart phone, tablet, ultrabook, netbook, laptop, multi-processor system, microprocessor-based or programmable consumer electronics system, game console, set-top box, or any other communication device that a user may utilize to access the networked system 102. In some embodiments, the client device 110 comprises a display module (not shown) to display information, such as in the form of user interfaces. In further embodiments, the client device 110 comprises one or more touch screens, accelerometers, gyroscopes, cameras, microphones, global positioning system (GPS) devices, and so forth. The client device 110 may be a device of a user that is used to access data analysis or industrial applications supported by the networked system 102. One or more users 106 may be a person, a machine, or other means of interacting with the client device 110. In embodiments, the user 106 is not part of the network architecture 100, but interacts with the network architecture 100 via the client device 110 or another means. For example, one or more portions of the communications network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a Wi-Fi® network, a WiMax network, another type of network, or a combination of two or more such networks.

The client device 110 may include one or more applications such as, but not limited to, a business or industrial application supported by the data analysis system 142. In some embodiments, the business or industrial application is included in one of the client devices 110, and the application is configured to locally provide the user interface and at least some of the functionalities to communicate with the networked system 102, on an as-needed basis, for data or processing capabilities not locally available. Conversely, in some embodiments, the business or industrial application is not included in the client device 110, and the client device 110 may use its web browser to access the business or industrial application (or a variant thereof) hosted on the networked system 102.

As noted herein, in embodiments, the user 106 is not part of the network architecture 100, but may interact with the network architecture 100 via the client device 110 or other means. For instance, the user 106 provides input to the client device 110 and the input is communicated to the networked system 102 via the communications network 104. In this instance, the networked system 102, in response to receiving the input from the user 106, communicates information to the client device 110 via the communications network 104 to be presented to the user 106. In this way, the user 106 can interact with the networked system 102 using the client device 110.

An application programming interface (API) server 120 and a web server 122 are coupled to, and provide programmatic and web interfaces respectively to, one or more application servers 140. As shown, the application server 140 hosts the data analysis system 142, which in addition to the inference ML model component 144, may include one or more additional modules, each of which may be embodied as hardware, software, firmware, or some combination thereof.

The application server 140 is shown to be coupled to one or more database servers 124 that facilitate access to one or more information storage repositories or databases 126. In an embodiment, the databases 126 are storage devices that store information, such as data generated and collected from an industrial device to be analyzed by the data analysis system 142.

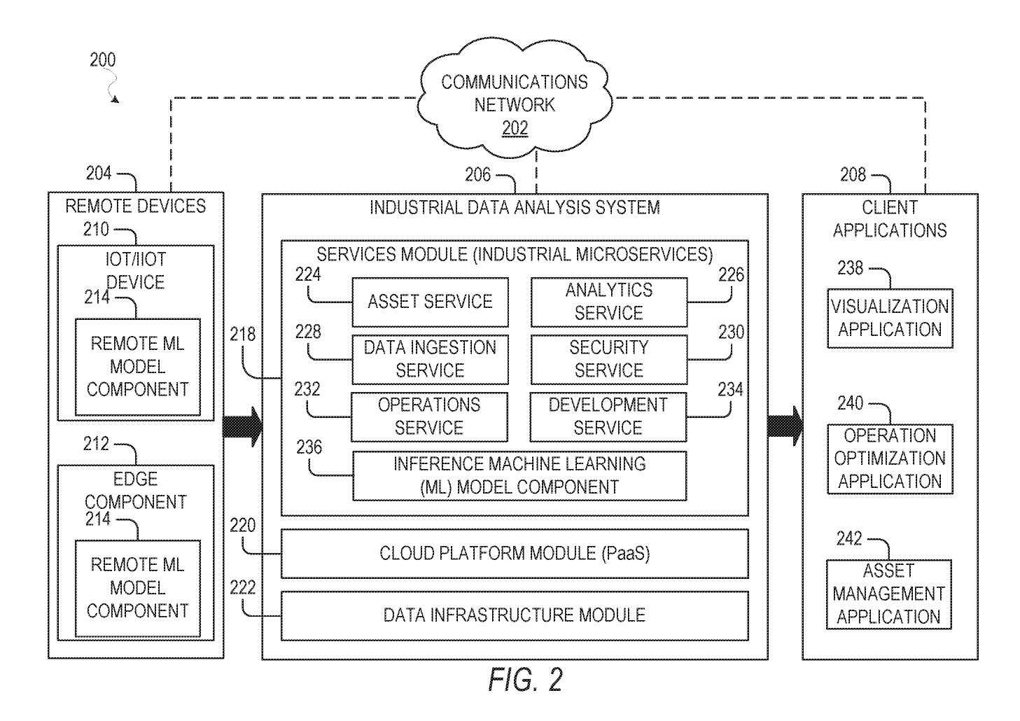

FIG. 2 is a block diagram illustrating an example system 200 including an inference machine learning (ML) model component 236 and a remote machine learning (ML) model component 214, according to some embodiments. As shown, the system 200 includes remote devices 204, an industrial data analysis system 206, one or more client applications 208, and a communications network 202 to facilitate data communication therebetween. The remote devices 204 can represent any device that can include the remote ML model component 214, collect data regarding itself, and process the collected data using the remote ML model component 214. The collected data may comprise event logs, error logs, time-series data, and the like. The data generated by the remote ML model component 214 may comprise encoded data or intermediate neural network output data, which may be provided to the industrial data analysis system 206 to perform analysis and other operations. As shown, the remote devices 204 include an IoT or Industrial IoT (HoT) device 210 and an edge component 212, such as an IoT/IIoT gateway, device controller, or sensor node.

For some embodiments, the industrial data analysis system 206 represents a machine-learning, data analysis platform, such as Predix®, which may use the inference ML model component 236 to process data provided by the remote device 204, such as the encoded data or intermediate neural network output data generated via the remote ML model component 214. The client applications 208 may represent those applications that use functions of, or data results generated by, the industrial data analysis system 206. As shown, the client applications 208 include a visualization application 238, an operation optimization application 240, and an asset management application 242, such as an industrial device software application.

The industrial data analysis system 206 includes a services module 218, a cloud platform module 220, and a data infrastructure module 222. The industrial data analysis system 206 can include a collection of software services and software development tools, which enable a user (e.g., an industrial customer) to use, or develop and use, applications for optimizing industrial business processes with respect to industrial devices. For instance, the industrial data analysis system 206 can monitor IIoT devices, digest data from such devices, analyze the digested data using services (e.g., microservices) provided by the services module 218, and make predictions using machine-learning (ML) implemented by one or more services of the services module 218.

The services module 218 can provide various industrial services that a development user can use to build an industrial software application, or pre-built software services (e.g., from a third-party vendor). As shown, the services module 218 includes an asset service 224, an analytics service 226, a data ingestion service 228, a security service 230, an operations service 232, a development service 234, and the inference ML model component 236. The asset service 224 may facilitate creation, importation, and organization of industrial device/asset models and associated business rules. The analytics service 226 may facilitate creation, cataloging, or orchestration of analytics on industrial devices, which can serve as a basis for industrial applications, such as the client applications 208. The data ingestion service 228 can facilitate ingestion, formatting, merging, or storage of data from an industrial device. The security service 230 may facilitate end-to-end security, authentication, or authorization between the industrial data analysis system 206 and other entities within the system 200. The operations service 232 may facilitate control and operation of industrial devices. The development service 234 may facilitate the development of industrial applications, by a development user, using the industrial data analysis system 206.

The cloud platform module 220 may comprise a cloud framework that enables various functions of the industrial data analysis system 206 to be built, or operated, as cloud-based services, such as a platform-as-a-service (PaaS).

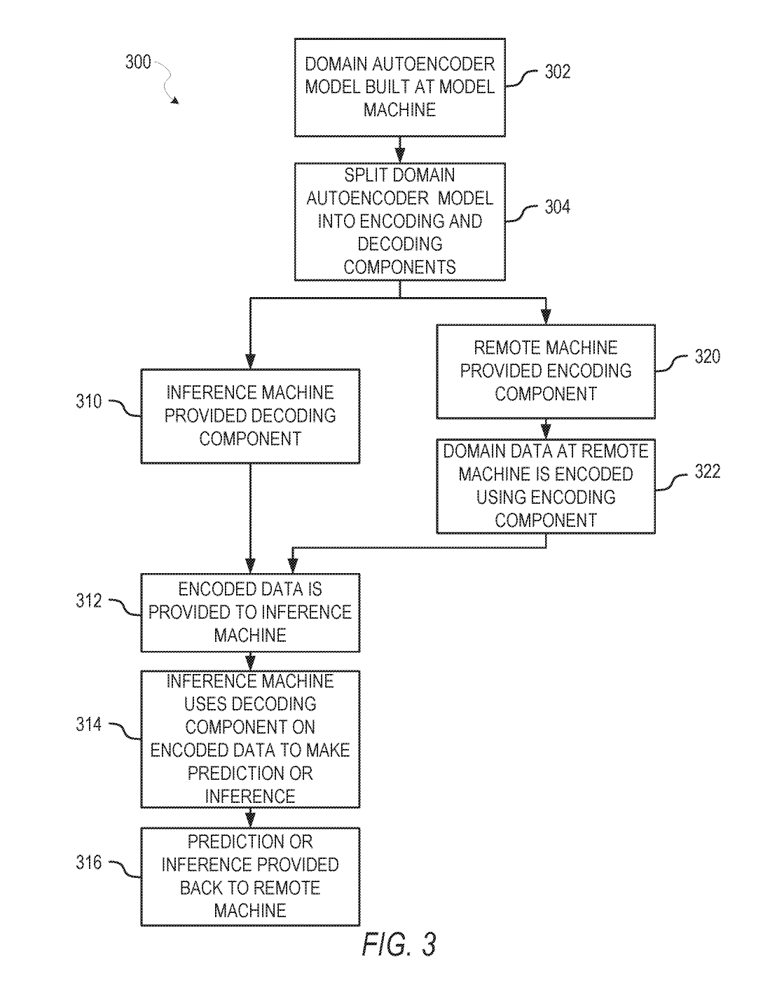

FIG. 3 is a flow chart illustrating an example method 300 for an autoencoder model, in accordance with some embodiments. For some embodiments, operations of the method 300 may be performed by one or more of a model machine, a remote machine, and an inference machine. An operation of the method 300 may be performed by a hardware processor, such as a central processing unit (CPU) or graphics processing unit (GPU), of a computing device, such as a desktop, laptop, server, cluster, or the like.

As shown in FIG. 3, the method 300 begins at operation 302, with a domain autoencoder machine learning model (hereafter, domain autoencoder model) being built at a model machine (e.g., a model-generation computing device). The model machine may be one that is responsible for one or more of creating, training, or managing a model. The domain autoencoder model may be built using an autoencoder on a corpus of data, which may comprise images, text, tabular, video, or time-series data.

The method 300 continues with operation 304, with the domain autoencoder model built at operation 302 being split into its encoding and decoding components. The method 300 continues with operation 310 and operations 320-322, where operation 310 may or may not be performed in parallel with one or more of operations 320-322. At operation 310, an inference machine (e.g., an inference computing device) is provided with a decoding component of the domain autoencoder model, where the providing may comprise sending the decoding component to the inference machine, for example over a communications network. The decoding component may be provided in response to a request, from the inference machine, for the decoding component.

At operation 320, a remote machine (e.g., an edge computing device) is provided with an encoding component of the domain autoencoder model, where the providing may comprise sending the encoding component to the remote machine, for example over a communications network. The encoding component may be provided in response to a request, from the remote machine, for the encoding component. The encoding component may be encrypted, for example by the model machine, using a machine-specific encryption key before being sent to the remote machine, and the encoding component may be sent with metadata relating to the encoding component. At operation 322, domain data at the remote machine, such as an MRI image, is encoded using the encoding component provided at operation 320, which results in encoded data. Additionally, the encoded domain data on the remote machine may comprise a compressed version of the original domain data.

The method 300 continues with operation 312, where the remote machine sends the encoded data to the inference machine that received the decoding component at operation 310. The encoded data may be encrypted, such as by a machine-specific encryption key, before being sent to the inference machine. Additionally, the encoded data may be sent with metadata relating to the encoded data, such as information regarding the encoding component that generated the encoded data. The method 300 continues with operation 314, where the inference machine uses the decoding component, obtained at operation 310, on the encoded data to make a prediction or inference. The method 300 continues with operation 316, where the inference machine provides (e.g., sends) the prediction or inference back to the remote machine.

Though the operations of the method 300, and other methods described herein, may be depicted and described in a certain order, the order in which the operations are performed may vary between embodiments. For instance, an operation may be performed before, after, or concurrently with another operation. Additionally, components or machines described herein with respect to various methods are merely examples of components or machines that may be used with those methods, and other components or machines may also be utilized in some embodiments.

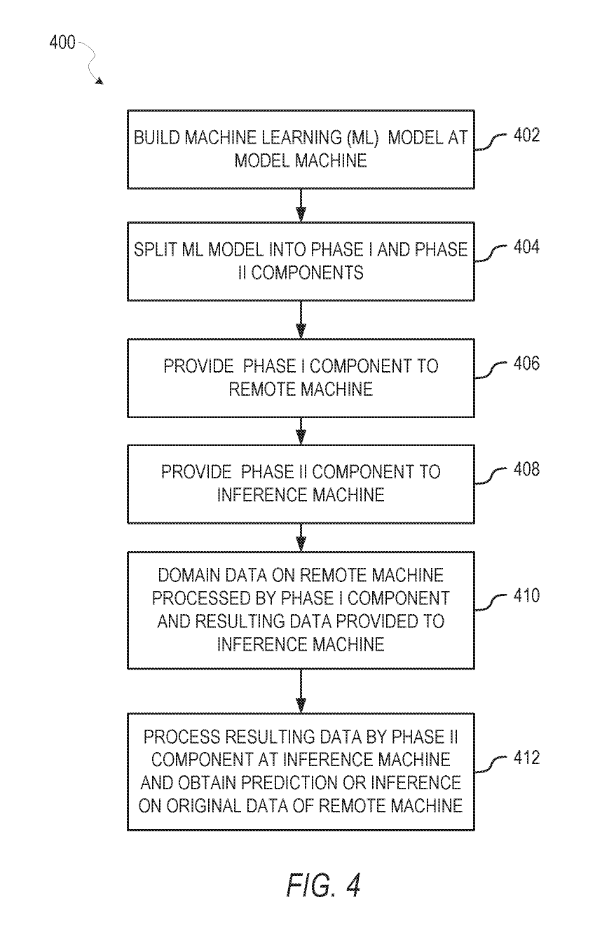

FIG. 4 is a flow chart illustrating an example method 400 for a machine learning (ML) model, in accordance with some embodiments. For some embodiments, operations of the method 400 may be performed by one or more of a model machine, a remote machine, and an inference machine. An operation of the method 400 may be performed by a hardware processor of a computing device.

As shown in FIG. 4, the method 400 begins with operation 402, where a machine learning (ML) model is built at a model machine (e.g., a model-generation computing device). As used herein, the model machine may be one that is responsible for one or more of creating, training, or managing a model. The ML model may be built using deep learning on a corpus of data, such as images, text, tabular, video, or time-series data.

The method 400 continues with operation 404, where the ML model is split into phase I and phase II components. The method 400 continues with operation 406, where the phase I component is provided to a remote machine, and the providing may comprise sending the phase I component to the remote machine, for example over a communications network. The phase I component may be provided in response to a request, from the remote machine, for the phase I component.

For some embodiments, the model machine is also an inference machine, which will use the phase II component in accordance with an embodiment. Where the model machine and the inference machine are different machines, the method 400 continues with operation 408 as shown, where the phase II component is provided to the inference machine, and the providing may comprise sending the phase II component to the inference machine, for example over a communications network. The phase II component may be provided in response to a request, from the inference machine, for the phase II component. The phase II component may be encrypted, for example by the model machine, using a machine-specific encryption key before being sent and may be accompanied by metadata relating to at least the phase II component.

The method 400 continues with operation 410, where domain data on the remote machine is processed by the phase I component and the resulting data is provided to the inference machine having the phase II component. For example, the resulting data may be sent by the remote machine to the inference machine over a communications network. The method 400 continues with operation 412, where the inference machine processes the resulting data, from the remote machine, by the phase II component at the inference machine, which results in a prediction or inference being obtained (at the inference machine) from the original data of the remote machine.

As used herein, metadata relating to a machine learning (ML) model or one of its components (e.g., encoder, decoder, or phase X component) can comprise at least one of the following: instructions (e.g., code) to transform unprocessed “raw” data (optionally sent metadata); link(s) to code/containers that transform unprocessed data (optionally sent metadata); an encoding (or phase X) component of the ML model (e.g. DNN, CNN, or RNN); and governance/provenance data, such as details about what domain data is appropriate for this process, a lifetime of validity of the process, an origin of the model, relevant URLs/links to send encoded data to, an ID of the model, or the creators of the model.

Various embodiments described herein can facilitate compression of data being sent from one computing device to another, which has a technical and commercial benefit. Compression may be achieved without need for a dictionary. Additionally, the encoding and decoding used may be auto-learnt and domain specific. Accordingly, there may be different encoders and decoders for different data domains. Once encoders and decoders are built on the cloud, the encoders may be placed on edge devices that can transmit the data after encoding it, thereby providing privacy as well as lowering bandwidth usage.

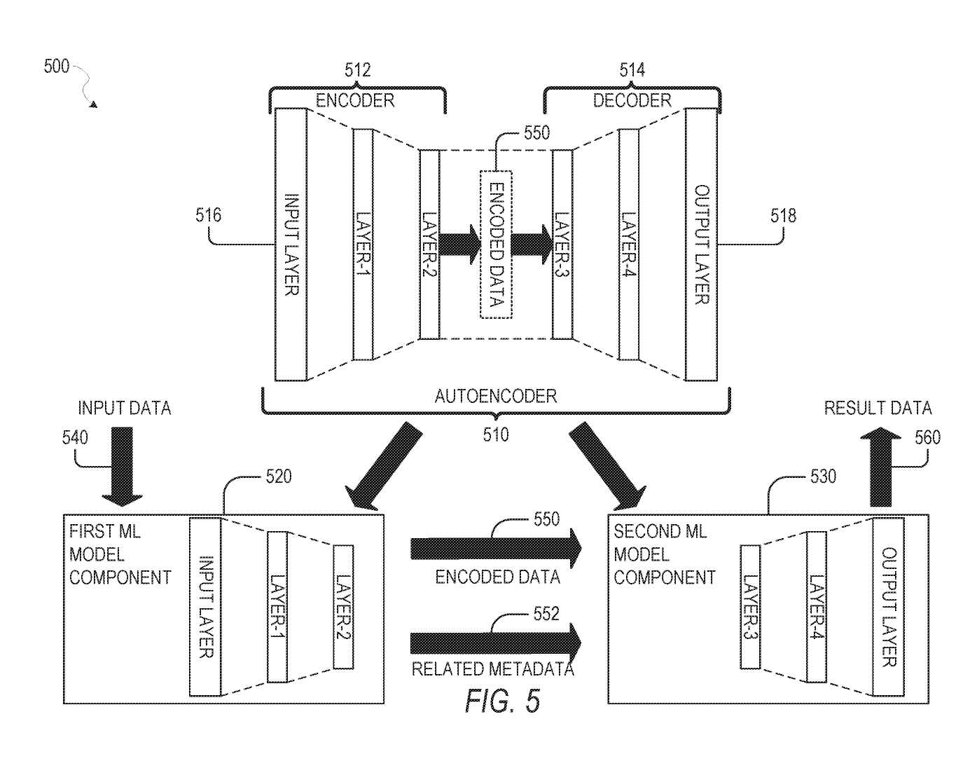

FIG. 5 is a diagram illustrating performance of an example method 500 on an example autoencoder machine learning (ML) model 510, in accordance with some embodiments. The autoencoder ML model 510 can represent an autoencoder trained on specific domain data, such as IIoT-generated data or medical data. As shown, the autoencoder ML model 510 comprises an encoder component 512, including an input layer 516, a layer-1, and a layer-2, and a decoder component 514, including a layer-3, a layer-4, and an output layer 518. During operation, the encoder component 512 of the autoencoder ML model 510 can receive input data 540 via the input layer 516 and produce encoded data 550 via the layer-2, and the decoder component 514 of the autoencoder ML model 510 can receive the encoded data 550 via the layer-3 and produce result data 560, which may represent a reconstruction of the input data 540. As described herein, the encoded data 550 may be encrypted prior to be being communicated from the first ML model component 520 to the second ML model component 530. Additionally, the encoded data 550 may be sent with metadata 552 relating to the encoded data 550, such as information regarding the first ML model component 520 that generated the encoded data 550. By the method 500, the autoencoder ML model 510 is split into a first ML model component 520 and a second ML model component 530 such that the first ML model component 520 comprises the encoder component 512, and the second ML model component 530 comprises the decoder component 514. In accordance with some embodiments, the first and second ML model components 520, 530 can be deployed to separate machines (e.g., computing devices) to facilitate obfuscation of domain-specific data communicated between the separate machines.

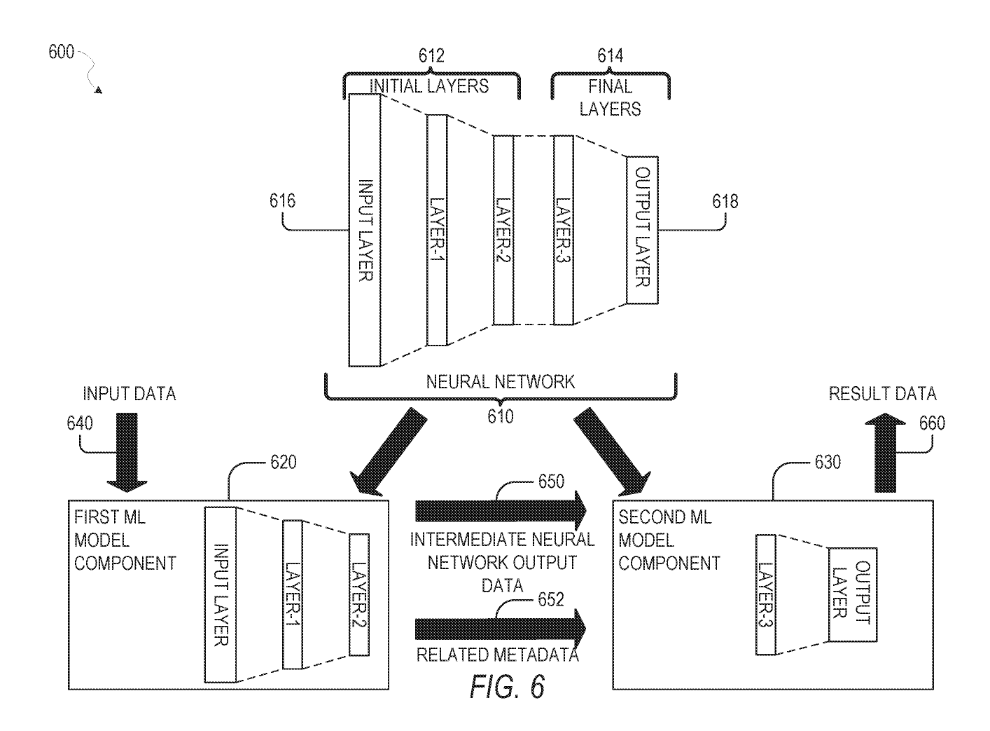

FIG. 6 is a diagram illustrating performance of an example method 600 on an example machine learning (ML) model comprising a neural network 610 that generates result data based on input data, in accordance with some embodiments. The neural network 610 can represent a neural network trained on specific domain data, such as IIoT-generated data or medical data. Accordingly, the neural network 610 can process domain-specific input data and generated result data based on the domain specific input data. As shown, the neural network 610 comprises initial layers 612, including an input layer 616, a layer-1, and a layer-2, and final layers 614, including a layer-3 and an output layer 618. During operation, the initial layers 612 receive input data 640 via the input layer 616 and produce intermediate neural network output data 650, and the final layers 614 receive the intermediate neural network output data 650 and produce result data 660, which may be a representation of the input data 640. As described herein, the intermediate neural network output data 650 may be encrypted prior to be being communicated from the first ML model component 620 to the second ML model component 630. Additionally, the intermediate neural network output data 650 may be sent with metadata 652 relating to the intermediate neural network output data 650, such as information regarding the first ML model component 620 that generated the intermediate neural network output data 650. By the method 600, the neural network 610 is split into a first ML model component 620 and a second ML model component 630 such that the first ML model component 620 comprises the initial layers 612 of the neural network 610, and the second ML model component 630 comprises the final layers 614 of the neural network 610. In accordance with some embodiments, the first and second ML model components 620, 630 can be deployed to separate machines (e.g., computing devices) to facilitate obfuscation of domain-specific data communicated between the separate machines.

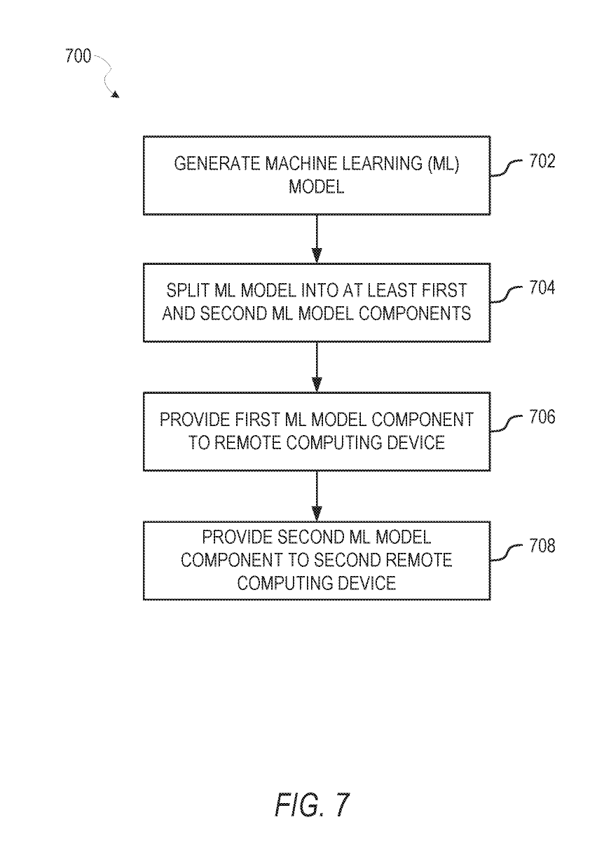

FIGS. 7-10 are flow charts illustrating example methods for a machine learning (ML) model, in accordance with some embodiments. An operation of the methods of FIGS. 7-10 may be performed by a hardware processor of a computing device. For some embodiments, operations of the methods of FIGS. 7-10 are performed by a model machine, which may comprise a computing device. Additionally, for some embodiments, the model machine also operates as an inference machine. For some embodiments, the inference machine may comprise a set of central servers that provides prediction services (e.g., as cloud services) based on at least one machine learning (ML) component generated by one of the methods of FIGS. 7-10.

Referring now to FIG. 7, a method 700 begins with operation 702, where a ML model, comprising a neural network, is generated, such as at the model machine. The generation of the neural network may comprise training the ML model on domain-specific training data, such as data relating to IIoT devices and medical images. The neural network may be configured to generate and output result data based on input data received by the neural network as input. The input data may comprise domain-specific data, such as data relating to an IIoT device or medical data (e.g., an MRI image). The result data can represent an inference made by the neural network based on a predictive model (e.g., a classification or regression model) implemented by the neural network. Where the neural network comprises an autoencoder ML model, the result data can represent a reconstruction of the input data received by the neural network. The reconstruction may comprise a smaller, approximate, and faithful reconstruction of the input data in view of a tunable loss parameter of the autoencoder ML model. For some embodiments, a prediction output is generated based on the result data of the neural network.

The method 700 continues with operation 704, where the ML model generated at operation 702 is split into a plurality of ML model components that includes at least a first ML model component and a second ML model component. The ML model may be split between two adjacent layers of the neural network. Splitting the ML model into at least the first ML model component and the second ML model component may comprise splitting the ML model to generate a first portion of the neural network that provides result data for the neural network and a second portion of the neural network that receives input data for the neural network. The first ML model component may comprise the first portion of the neural network and the second ML model component may comprise the second portion of the neural network, or vice versa.

For some embodiments, the first ML model component comprises a set of initial layers of the neural network, and the second ML model component comprises a set of final layers of the neural network. In this case, where the first ML model component is received by a remote machine, the remote machine can use the first ML model component to generate, based on input data, intermediate neural network output data that the remote machine sends to another machine that is using the second ML model component.

Alternatively, for some embodiments, the first ML model component comprises a set of final layers of the neural network, and the second ML model component comprises a set of initial layers of the neural network. In this case, where the first ML model component is received by a remote machine, the remote machine can use the first ML model component to produce result data based on intermediate neural network output data that was produced by another machine using the second ML model component.

Additionally, for some embodiments, the neural network comprises an autoencoder ML model, the first ML model component comprises an encoder neural network of the autoencoder ML model, and the second ML model component comprises a decoder neural network of the autoencoder ML model. Alternatively, for some embodiments, the neural network comprises an autoencoder ML model, the first ML model component comprises a decoder neural network of the autoencoder ML model, and the second ML model component comprises an encoder neural network of the autoencoder ML model.

In further embodiments, the neural network comprises an autoencoder ML model, where the first ML model component comprises a first portion of the decoder neural network and where the second ML model component comprises a second portion of the decoder neural network and the encoder neural network. For such embodiments, the second portion of the decoder neural network and the encoder neural network may be coupled together within the second ML model component. Alternatively, for some embodiments, the neural network comprises an autoencoder ML model, where the first ML model component comprises the decoder neural network and a first portion of the encoder neural network, and where the second ML model component comprises a second portion of the encoder neural network. For such embodiments, the decoder neural network and the first portion of the encoder neural network may be coupled together within the first ML model component.

The method 700 continues with operation 706, where the first ML model component is provided to a remote computing device, which may operate as a remote machine. The providing may comprise sending, or otherwise distributing, the first ML model component to the remote computing device, such as over a communication network. Where the model machine also comprises the inference machine, the second ML model component may be retained at the model/inference machine and used at the model/inference machine to process data eventually produced by the remote computing device using the first ML model component. Alternatively, the model machine may retain the second ML model component to produce data eventually sent to the remote computing device for use with the first ML model component.

The method 700 continues with operation 708, where the second ML model component is provided to a second remote computing device. The providing may comprise sending, or otherwise distributing, the second ML model component to the second remote computing device, such as over a communication network. For some embodiments, the second remote computing device comprises an edge computing device, which may be part of a system relating to industrial devices, such as Industrial IoT (IIoT) devices. For instance, the second remote computing device may comprise an edge computing device that generates intermediate neural network output data by using the second ML model component to process input data that is based on (e.g., comprises) data received from an industrial device. Subsequently, the (first) remote computing device may receive the intermediate neural network output data from the second remote computing device. The first remote computing device may comprise a data analysis system that (1) generates result data by processing the intermediate neural network output data using the first ML model component and (2) generates analysis or prediction data for the industrial device based on the result data. The output data generated by the first ML model component may comprise inference data, and the analysis data may comprise a prediction in view of the inference data.

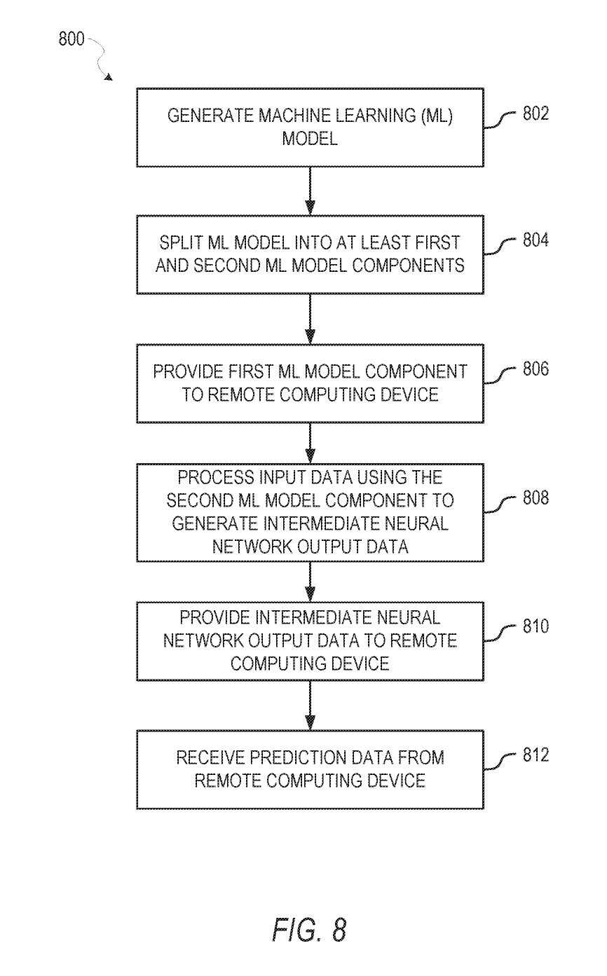

Referring now to FIG. 8, a method 800 begins with operations 802-806, which in accordance with some embodiments, are respectively similar to operations 702-706 of the method 700 described above with respect to FIG. 7. For example, with respect to operation 804, where the ML model comprises a neural network, the first ML model component comprises a first portion of the neural network that provides result data for the neural network, and the second ML model component comprises a second portion of the neural network that receives input data for the neural network. Additionally, where the ML model comprises an autoencoder ML model, the first ML model component comprises a decoder neural network of the autoencoder ML model, and the second ML model component comprises an encoder neural network of the autoencoder ML model.

After operation 806, the method 800 continues with operation 808, where input data is processed using the second ML model component to generate intermediate neural network output data. As described herein, the input data can comprise data that is specific to the domain (e.g., medical imaging) upon which the ML model was generated and trained at operation 802.

The method 800 continues with operation 810, where the intermediate neural network output data, generated at operation 808, is provided to the remote computing device. For some embodiments, the intermediate neural network output data represents data transferred between two layers of a neural network. Accordingly, by providing the intermediate neural network output data to the remote computing device having the first ML model component, an embodiment can transfer the intermediate neural network output data from a final layer of the second ML model component to an initial layer of the first ML model component. Prior to being provided to the remote computing device, the intermediate neural network output data may be encrypted, such as by a machine-specific encryption key. Additionally, the intermediate neural network output data may be provided with metadata relating to the intermediate neural network output data, such as information regarding the second ML model component that generated the intermediate neural network output data, which can include versioning information regarding the architecture of the second ML model component.

The method 800 continues with operation 812, where prediction data is received from the remote computing device. According to some embodiments, the prediction data is based on result data generated, at the remote computing device, by the first ML model component processing the intermediate neural network output data provided to the remote computing device. The result data may comprise inference data produced by the first ML model component.

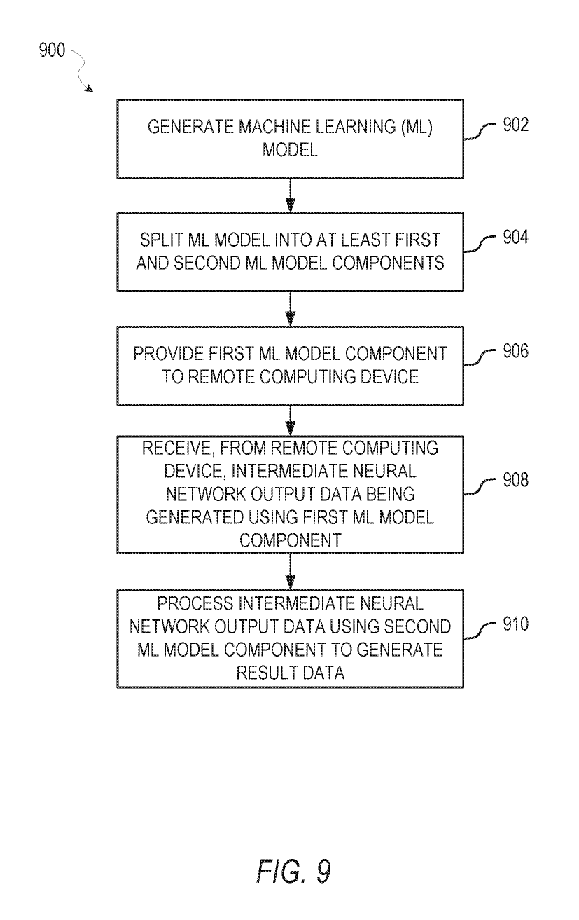

Referring now to FIG. 9, a method 900 begins with operations 902-906, which in accordance with some embodiments, are respectively similar to operations 702-706 of the method 700 described above with respect to FIG. 7. For example, with respect to operation 904, where the ML model comprises a neural network, the first ML model component comprises a first portion of the neural network that receives input data for the neural network, and the second ML model component comprises a second portion of the neural network that provides result data for the neural network. Additionally, where the ML model comprises an autoencoder ML model, the first ML model component comprises an encoder neural network of the autoencoder ML model, and the second ML model component comprises a decoder neural network of the autoencoder ML model.

After operation 906, the method 900 continues with operation 908, where intermediate neural network output data is received from the remote computing device. According to some embodiments, the intermediate neural network output data is generated by processing input data, at the remote computing device, using the first ML model component, which for example may comprise an encoder neural network. The method 900 continues with operation 910, where the intermediate neural network output data, received from the remote computing device, is processed using the second ML model component to generate result data. As described herein, the second ML model component may comprise a decoder neural network. As described herein, the result data generated by the second ML model component may be used to provide a prediction based on the input data received by the first ML model component.

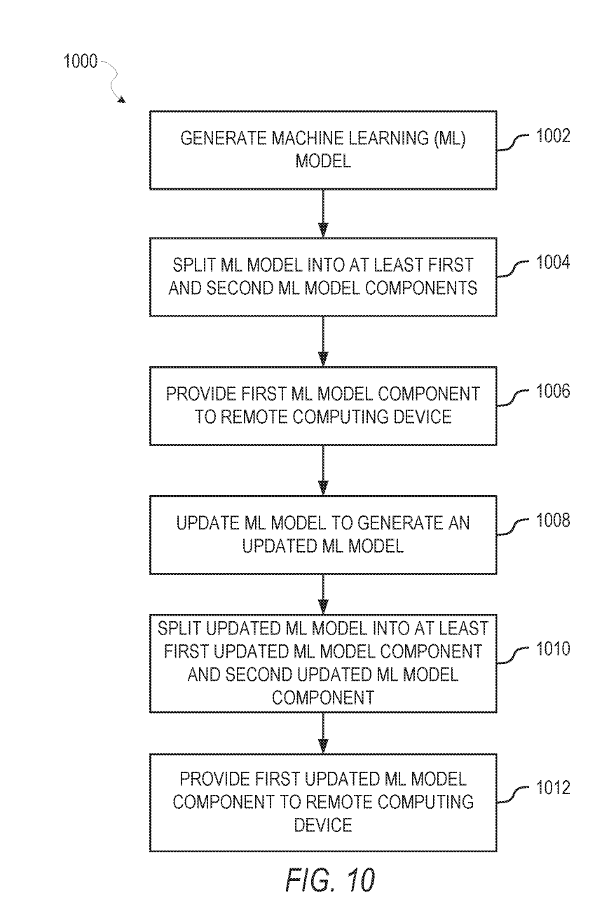

Referring now to FIG. 10, a method 1000 begins with operations 1002-1006, which in accordance with some embodiments, are respectively similar to operations 702-706 of the method 700 described above with respect to FIG. 7. After operation 1006, the method 1000 continues with operation 1008, where the ML model is updated to generate an updated ML model. For instance, an update to the ML model may comprise a topology change to the neural network of the ML model, such as a change from the neural network model being a twelve-layer network to a fifteen-layer network. In another example, an update to the ML model may comprise an update to weight data of one or more layers of the neural network of the ML model. In another example, an update to the ML model may comprise retraining the ML model with new training data.

The method 1000 continues with operation 1010, where the updated ML model is split into at least a first updated ML model component and a second updated ML model component. Thereafter, the method 1000 continues with operation 1012, where the first updated ML model component is provided to the remote computing device. For instance, where the updated ML model comprises an updated autoencoder ML model, the first updated ML model component may comprise an updated encoder neural network. For some embodiments, providing the first updated ML model component comprises providing metadata that represents a set of updates for updating the first ML model component to the first updated ML model component. Example metadata can include, without limitation, changes to weight data to those portions of the ML model included in the first ML model component, or parameters relating to one or more neural network layers included in the first ML model component.

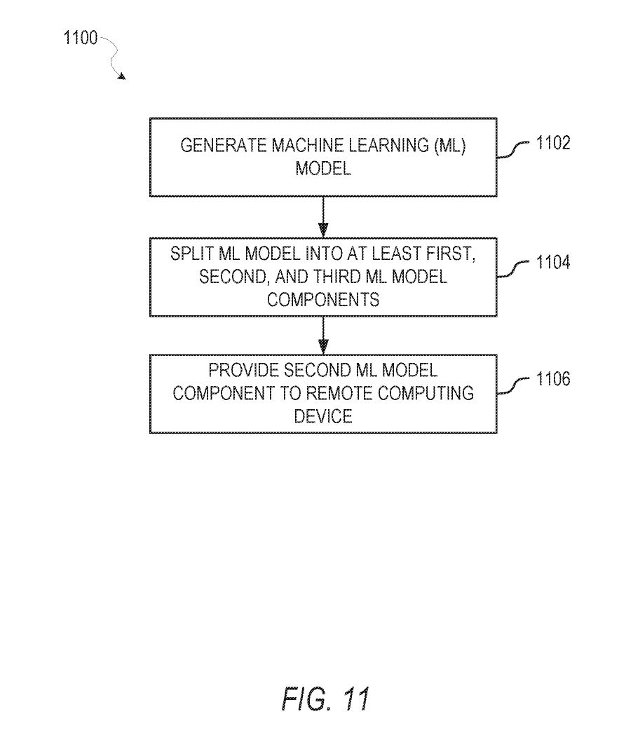

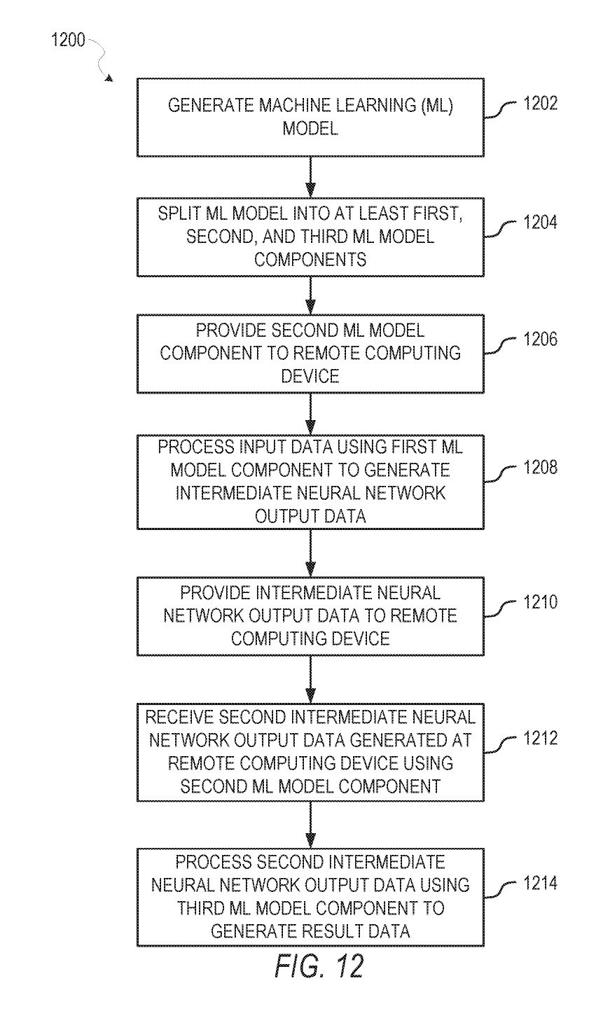

FIGS. 11-12 are flow charts illustrating example methods for a machine learning (ML) model, in accordance with some embodiments. An operation of the methods of FIGS. 11-12 may be performed by a hardware processor of a computing device. For some embodiments, operations of the methods of FIGS. 11-12 are performed by a model machine, which may comprise a computing device. Additionally, for some embodiments, the model machine also operates as an inference machine. For some embodiments, the inference machine may comprise a set of central servers that provides prediction services (e.g., as cloud services) based on at least one machine learning (ML) component generated by one of the methods of FIGS. 11-12.

Referring now to FIG. 11, a method 1100 begins with operation 1102, which in accordance with some embodiments, is similar to operation 702 of the method 700 described above with respect to FIG. 7. After operation 1102, the method 1100 continues with operation 1104, where the ML model generated at operation 1102 is split into a plurality of ML model components that includes at least a first ML model component, a second ML model component, and a third ML model component. As described herein, the ML model may be split between two adjacent layers of the neural network. For some embodiments, the ML model is split at operation 1104 such that the first ML model component comprises a series of initial layers of the neural network at one end of the neural network, the second ML model component comprises a series of intervening layers of the neural network, and the third ML model component comprises a series of end layers of the neural network. The series of initial layers of the neural network may receive and process input data to produce first intermediate neural network output data. The series of intervening layers of the neural network may receive and process the first intermediate neural network output data to produce second intermediate neural network output data. The series of end layers of the neural network may receive and process the second intermediate neural network output data to produce result data. As described herein, the result data may comprise inference data produced by the first ML model component.

The method 1100 continues with operation 1106, where the second ML model component is provided to a remote computing device. As described herein, the providing may comprise sending, or otherwise distributing, the second ML model component to the remote computing device, such as over a communication network. Where the model machine also comprises the inference machine, the first and third ML model components may be retained at the model/inference machine and used at the model/inference machine to process data eventually produced by the remote computing device using the second ML model component.

Referring now to FIG. 12, a method 1200 begins with operations 1202-1206, which in accordance with some embodiments, are similar to operations 1102-1106 of the method 1100 described above with respect to FIG. 11. After operation 1206, the method 1200 continues with operation 1208, where input data is processed using the first ML model component to generate intermediate neural network output data. The method 1200 continues with operation 1210, where the intermediate neural network output data, generated at operation 1208, is provided to the remote computing device.

The method 1200 continues with operation 1212, where second intermediate neural network output data, generated at the remote computing device using the second ML model component provided to it at operation 1206, is received. The second intermediate neural network output data may be received directly from the remote computing device. According to some embodiments, the second intermediate neural network output data is generated at the remote computing device by using the second ML model component to process the intermediate neural network output data received by the remote computing device during operation 1210. The method 1200 continues with operation 1214, where the second intermediate neural network output data is processed, using the third ML model component, to generate result data. As described herein, the result data may comprise inference data produced by the first ML model component.

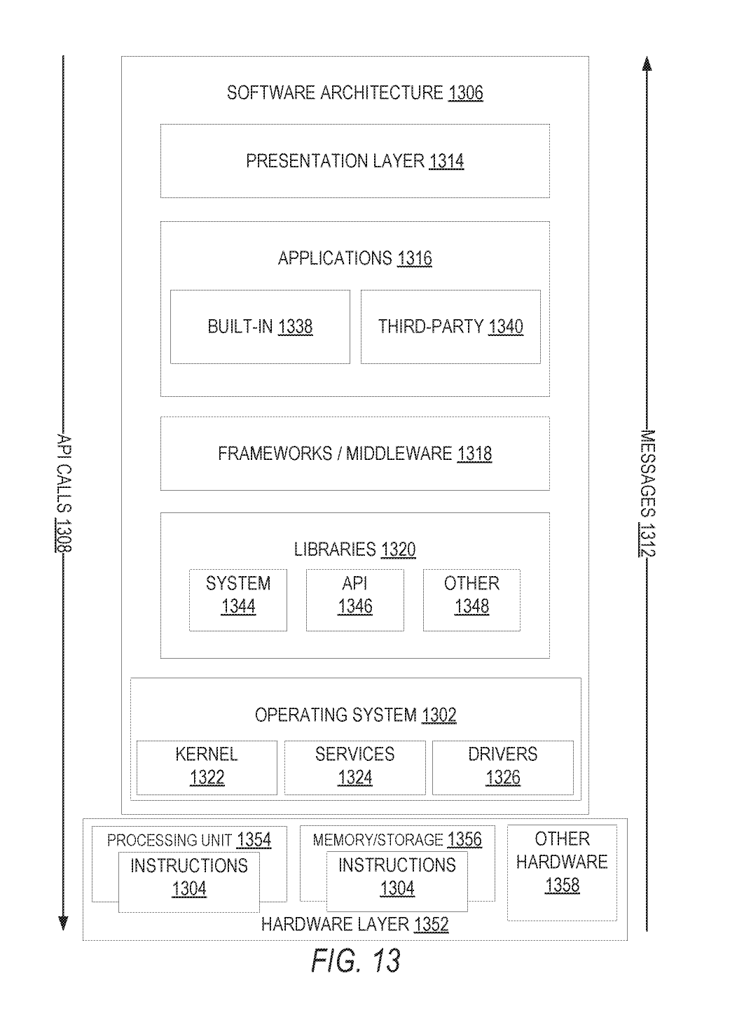

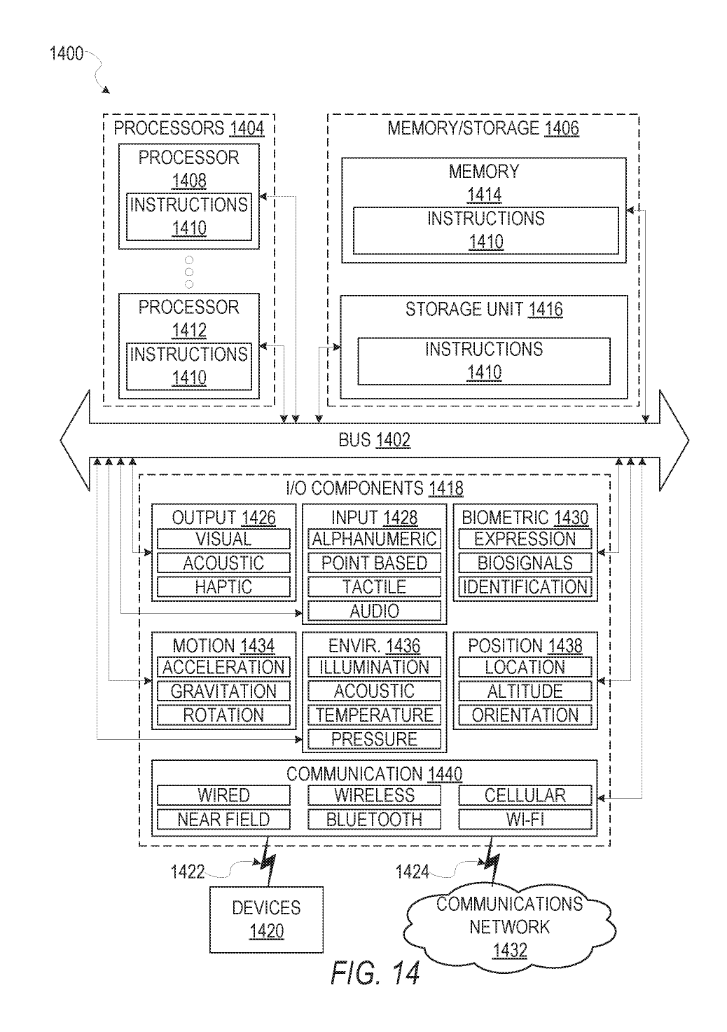

Various embodiments described herein may be implemented by way of the example software architecture illustrated by and described with respect to FIG. 13 or by way of the example machine illustrated by and described with respect to FIG. 14.

FIG. 13 is a block diagram illustrating an example software architecture 1306, which may be used in conjunction with various hardware architectures herein described. FIG. 13 is a non-limiting example of a software architecture and it will be appreciated that many other architectures may be implemented to facilitate the functionality described herein. The software architecture 1306 may execute on hardware such as a machine 1400 of FIG. 14 that includes, among other things, processors 1404, memory 1414, and 1/O components 1418. A representative hardware layer 1352 is illustrated and can represent, for example, the machine 1400 of FIG. 14. The representative hardware layer 1352 includes a processing unit 1354 having associated executable instructions 1304. The executable instructions 1304 represent the executable instructions of the software architecture 1306, including implementation of the methods, components, and so forth described herein. The hardware layer 1352 also includes memory and/or memory/storage modules 1356, which also have the executable instructions 1304. The hardware layer 1352 may also comprise other hardware 1358.

In the example architecture of FIG. 13, the software architecture 1306 may be conceptualized as a stack of layers where each layer provides particular functionality. For example, the software architecture 1306 may include layers such as an operating system 1302, libraries 1320, frameworks/middleware 1318, applications 1316, and a presentation layer 1314. Operationally, the applications 1316 and/or other components within the layers may invoke application programming interface (API) calls 1308 through the software stack and receive messages 1312 in response to the API calls 1308. The layers illustrated are representative in nature and not all software architectures have all layers. For example, some mobile or special-purpose operating systems 1302 may not provide a frameworks/middleware 1318, while others may provide such a layer. Other software architectures may include additional or different layers.

The operating system 1302 may manage hardware resources and provide common services. The operating system 1302 may include, for example, a kernel 1322, services 1324, and drivers 1326. The kernel 1322 may act as an abstraction layer between the hardware and the other software layers. For example, the kernel 1322 may be responsible for memory management, processor management (e.g., scheduling), component management, networking, security settings, and so on. The services 1324 may provide other common services for the other software layers. The drivers 1326 are responsible for controlling or interfacing with the underlying hardware. For instance, the drivers 1326 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1320 provide a common infrastructure that is used by the applications 1316 and/or other components and/or layers. The libraries 1320 provide functionality that allows other software components to perform tasks in an easier fashion than by interfacing directly with the underlying operating system 1302 functionality (e.g., kernel 1322, services 1324, and/or drivers 1326). The libraries 1320 may include system libraries 1344 (e.g., C standard library) that may provide functions such as memory allocation functions, string manipulation functions, mathematical functions, and the like. In addition, the libraries 1320 may include API libraries 1346 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1320 may also include a wide variety of other libraries 1348 to provide many other APIs to the applications 1316 and other software components/modules.

The frameworks/middleware 1318 provide a higher-level common infrastructure that may be used by the applications 1316 and/or other software components/modules. For example, the frameworks/middleware 1318 may provide various graphic user interface (GUI) functions, high-level resource management, high-level location services, and so forth. The frameworks/middleware 1318 may provide a broad spectrum of other APIs that may be used by the applications 1316 and/or other software components/modules, some of which may be specific to a particular operating system 1302 or platform.

The applications 1316 include built-in applications 1338 and/or third-party applications 1340. Examples of representative built-in applications 1338 may include, but are not limited to, a contacts application, a browser application, a book reader application, a location application, a media application, a messaging application, and/or a game application. The third-party applications 1340 may include an application developed using the Android™ or iOS™ software development kit (SDK) by an entity other than the vendor of the particular platform, and may be mobile software running on a mobile operating system such as iOS™, Android™, Windows® Phone, or other mobile operating systems. The third-party applications 1340 may invoke the API calls 1308 provided by the mobile operating system (such as the operating system 1302) to facilitate functionality described herein.

The applications 1316 may use built-in operating system functions (e.g., kernel 1322, services 1324, and/or drivers 1326), libraries 1320, and frameworks/middleware 1318 to create user interfaces to interact with users of the system. Alternatively, or additionally, in some systems, interactions with a user may occur through a presentation layer, such as the presentation layer 1314. In these systems, the application/component “logic” can be separated from the aspects of the application/component that interact with a user.

FIG. 14 is a block diagram illustrating components of an example machine 1400, according to some embodiments, able to read instructions 1410 from a machine storage medium and perform any one or more of the methodologies discussed herein. Specifically, FIG. 14 shows a diagrammatic representation of the machine 1400 in the example form of a computer system, within which the instructions 1410 (e.g., software, a program, an application, an applet, an app, or other executable code) for causing the machine 1400 to perform any one or more of the methodologies discussed herein may be executed. As such, the instructions 1410 may be used to implement modules or components described herein. The instructions 1410 transform the general, non-programmed machine 1400 into a particular machine 1400 programmed to carry out the described and illustrated functions in the manner described. In alternative embodiments, the machine 1400 operates as a standalone device or may be coupled (e.g., networked) to other machines. In a networked deployment, the machine 1400 may operate in the capacity of a server machine or a client machine in a server-client network environment, or as a peer machine in a peer-to-peer (or distributed) network environment. The machine 1400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 1400 capable of executing the instructions 1410, sequentially or otherwise, that specify actions to be taken by that machine 1400. Further, while only a single machine 1400 is illustrated, the term “machine” shall also be taken to include a collection of machines 1400 that individually or jointly execute the instructions 1410 to perform any one or more of the methodologies discussed herein.

The machine 1400 may include processors 1404, memory/storage 1406, and I/O components 1418, which may be configured to communicate with each other such as via a bus 1402. The processors 1404 may comprise a single processor or, as shown, comprise multiple processors (e.g., processors 1408 and 1412). The memory/storage 1406 may include a memory 1414, such as a main memory, or other memory storage, and a storage unit 1416, both accessible to the processors 1404 such as via the bus 1402. The storage unit 1416 and memory 1414 store the instructions 1410 embodying any one or more of the methodologies or functions described herein. The instructions 1410 may also reside, completely or partially, within the memory 1414, within the storage unit 1416, within at least one of the processors 1404 (e.g., within the processor 1408's cache memory), or any suitable combination thereof, during execution thereof by the machine 1400. Accordingly, the memory 1414, the storage unit 1416, and the memory of the processors 1404 are examples of machine storage media.

The I/O components 1418 may include a wide variety of components to receive input, provide output, produce output, transmit information, exchange information, capture measurements, and so on. The specific I/O components 1418 that are included in a particular machine 1400 will depend on the type of machine. For example, portable machines such as mobile phones will likely include a touch input device or other such input mechanisms, while a headless server machine will likely not include such a touch input device. It will be appreciated that the I/O components 1418 may include many other components that are not shown in FIG. 14. The I/O components 1418 are grouped according to functionality merely for simplifying the following discussion and the grouping is in no way limiting. In various embodiments, the I/O components 1418 may include output components 1426 and input components 1428. The output components 1426 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1428 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further embodiments, the I/O components 1418 may include biometric components 1430, motion components 1434, environment components 1436, or position components 1438 among a wide array of other components. For example, the biometric components 1430 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1434 may include acceleration sensor components (e.g., accelerometer), gravitation sensor components, rotation sensor components (e.g., gyroscope), and so forth. The environment components 1436 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas sensors to detect concentrations of hazardous gases for safety or to measure pollutants in the atmosphere), or other components that may provide indications, measurements, or signals corresponding to a surrounding physical environment. The position components 1438 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1418 may include communication components 1440 operable to couple the machine 1400 to a communications network 1432 or devices 1420 via a coupling 1424 and a coupling 1422 respectively. For example, the communication components 1440 may include a network interface component or other suitable device to interface with the communications network 1432. In further examples, the communication components 1440 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1420 may be another machine or any of a wide variety of peripheral devices (e.g., a peripheral device coupled via a USB).

Moreover, the communication components 1440 may detect identifiers or include components operable to detect identifiers. For example, the communication components 1440 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1440, such as location via Internet Protocol (IP) geolocation, location via Wi-Fi® signal triangulation, location via detecting an NFC beacon signal that may indicate a particular location, and so forth.

It will be understood that “various components” (e.g., modules) used in this context (e.g., system components) refers to a device, a physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function or related functions. Components may constitute either software components (e.g., code embodied on a machine storage medium) or hardware components. A hardware component is a tangible unit capable of performing certain operations and may be configured or arranged in a certain physical manner. In various embodiments, one or more computer systems (e.g., a standalone computer system, a client computer system, or a server computer system) or one or more hardware components of a computer system (e.g., a processor 1408 or a group of processors 1404) may be configured by software (e.g., an application 1316 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor 1408 or other programmable processor 1408. Once configured by such software, hardware components become specific machines (or specific components of a machine 1400) uniquely tailored to perform the configured functions and are no longer general-purpose processors 1404. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor 1408 configured by software to become a special-purpose processor, the general-purpose processor 1408 may be configured as respectively different special-purpose processors (e.g., comprising different hardware components) at different times. Software accordingly configures a particular processor 1408 or processors 1404, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between or among such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors 1404 that are temporarily configured (e.g., by software) or permanently configured to perform the relevant operations. Whether temporarily or permanently configured, such processors 1404 may constitute processor-implemented components that operate to perform one or more operations or functions described herein. As used herein, “processor-implemented component” refers to a hardware component implemented using one or more processors 1404. Similarly, the methods described herein may be at least partially processor-implemented, with a particular processor 1408 or processors 1404 being an example of hardware. For example, at least some of the operations of a method may be performed by one or more processors 1404 or processor-implemented components. Moreover, the one or more processors 1404 may also operate to support performance of the relevant operations in a “cloud computing” environment or as a “software as a service” (SaaS). For example, at least some of the operations may be performed by a group of computers (as examples of machines 1400 including processors 1404), with these operations being accessible via a communications network 1432 (e.g., the Internet) and via one or more appropriate interfaces (e.g., an API). The performance of certain of the operations may be distributed among the processors 1404, not only residing within a single machine 1400, but deployed across a number of machines 1400. In some embodiments, the processors 1404 or processor-implemented components may be located in a single geographic location (e.g., within a home environment, an office environment, or a server farm). In other embodiments, the processors 1404 or processor-implemented components may be distributed across a number of geographic locations.

“CLIENT DEVICE” in this context refers to any machine that interfaces to a communications network to obtain resources from one or more server systems or other client devices. A client device may be, but is not limited to, a mobile phone, desktop computer, laptop, PDA, smart phone, tablet, ultrabook, netbook, laptop, multi-processor system, microprocessor-based or programmable consumer electronics system, game console, set-top box, or any other communication device that a user may use to access a network.

“COMMUNICATIONS NETWORK” in this context refers to one or more portions of a network that may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or another type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long range protocols, or other data transfer technology.

“MACHINE STORAGE MEDIUM” in this context refers to a component, a device, or other tangible media able to store instructions and data temporarily or permanently and may include, but is not limited to, random-access memory (RAM), read-only memory (ROM), buffer memory, flash memory, optical media, magnetic media, cache memory, other types of storage (e.g., erasable programmable read-only memory (EPROM)), and/or any suitable combination thereof. The term “machine storage medium” should be taken to include a single medium or multiple media (e.g., a centralized or distributed database, or associated caches and servers) able to store instructions. The term “machine storage medium” shall also be taken to include any medium, or combination of multiple media, that is capable of storing instructions (e.g, code) for execution by a machine, such that the instructions, when executed by one or more processors of the machine, cause the machine to perform any one or more of the methodologies described herein. Accordingly, a “machine storage medium” refers to a single storage apparatus or device, as well as “cloud-based” storage systems or storage networks that include multiple storage apparatus or devices. The machine storage medium is non-transitory and, as such, excludes signals per se. A computer storage medium is an example of a machine storage medium. The term “communications medium” in this context includes modulated data signals and other carrier/communication experience elements. The term “machine-readable medium” in this context includes both a machine storage medium (e.g., a computer storage medium) and a communications medium.

“PROCESSOR” in this context refers to any circuit (e.g., hardware processor) or virtual circuit (e.g., a physical circuit emulated by logic executing on an actual processor) that manipulates data values according to control signals (e.g., “commands,” “op codes,” “machine code,” etc.) and which produces corresponding output signals that are applied to operate a machine. A processor may, for example, be a central processing unit (CPU), a Reduced Instruction Set Computing (RISC) processor, a Complex Instruction Set Computing (CISC) processor, a graphics processing unit (GPU), a digital signal processor (DSP), an ASIC, a Radio-Frequency Integrated Circuit (RFIC), or any combination thereof. A processor may further be a multi-core processor having two or more independent processors (sometimes referred to as “cores”) that may execute instructions contemporaneously.

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A method comprising:
generating, by one or more hardware processors, a machine learning model comprising a neural network that generates result data based on input data;
splitting, by the one or more hardware processors, the machine learning model into at least a first machine learning model component and a second machine learning model component; and
providing, by the one or more hardware processors, the first machine learning model component to a remote computing device.

2. The method of claim 1, wherein the splitting the machine learning model into at least the first machine learning model component and the second machine learning model component comprises: splitting the machine learning model to generate a first portion of the neural network that provides the result data for the neural network and a second portion of the neural network that receives the input data for the neural network, wherein the first machine learning model component comprises the first portion of the neural network, and wherein the second machine learning model component comprises the second portion of the neural network.

3. The method of claim 1, wherein the neural network comprises an autoencoder, wherein the autoencoder comprises an encoder neural network and a decoder neural network, wherein the first machine learning model component comprises the decoder neural network, and wherein the second machine learning model component comprises the encoder neural network.

4. The method of claim 1, wherein the neural network comprises an autoencoder, wherein the autoencoder comprises an encoder neural network and a decoder neural network, wherein the first machine learning model component comprises the encoder neural network, and wherein the second machine learning model component comprises the decoder neural network.

5. The method of claim 1, wherein the neural network comprises an autoencoder, wherein the autoencoder comprises an encoder neural network and a decoder neural network, wherein the first machine learning model component comprises a first portion of the decoder neural network, and wherein the second machine learning model component comprises a second portion of the decoder neural network and the encoder neural network.

6. The method of claim 1, wherein the neural network comprises an autoencoder, wherein the autoencoder comprises an encoder neural network and a decoder neural network, wherein the first machine learning model component comprises the decoder neural network and a first portion of the encoder neural network, and wherein the second machine learning model component comprises a second portion of the encoder neural network.

7. The method of claim 1, further comprising:
processing, by the one or more hardware processors, the input data using the second machine learning model component, to generate intermediate neural network output data; and
providing, by the one or more hardware processors, the intermediate neural network output data to the remote computing device.

8. The method of claim 8, further comprising:
receiving, by the one or more hardware processors, prediction data from the remote computing device, the prediction data being based on the result data generated by the first machine learning model component processing the intermediate neural network output data provided to the remote computing device.

9. The method of claim 1, further comprising:
receiving, by the one or more hardware processors, intermediate neural network output data from the remote computing device, the intermediate neural network output data being generated at the remote computing device using the first machine learning model component; and
processing, by the one or more hardware processors, the intermediate neural network output data, using the second machine learning model component, to generate the result data.

10. The method of claim 1, further comprising:
providing, by the one or more hardware processors, the second machine learning model component to a second remote computing device.

11. The method of claim 11, wherein the second remote computing device comprises an edge computing device that is configured to generate intermediate neural network output data by using the second machine learning model component to process input data based on data received from an industrial device, and
the remote computing device comprises a data analysis system that is configured to generate the result data by processing the intermediate neural network output data using the first machine learning model component and that generates analysis data for the industrial device based on the result data.

12. The method of claim 1, further comprising:
updating, by the one or more hardware processors, the machine learning model to generate an updated machine learning model;
splitting, by the one or more hardware processors, the updated machine learning model into at least a first updated machine learning model component and a second updated machine learning model component; and
providing, by the one or more hardware processors, the first updated machine learning model component to the remote computing device.

13. The method of claim 13, wherein providing the first updated machine learning model component to the remote computing device comprises providing metadata that represents a set of updates for updating the first machine learning model component to the first updated machine learning model component.

14. A method comprising:
generating, by one or more hardware processors, a machine learning model comprising a neural network that generates result data based on input data;
splitting, by the one or more hardware processors, the machine learning model into at least a first machine learning model component, a second machine learning model component, and a third machine learning model component such that the first machine learning model component comprises a series of initial layers of the neural network at one end of the neural network, the second machine learning model component comprises a series of intervening layers of the neural network, and the third machine learning model component comprises a series of end layers of the neural network; and
providing, by the one or more hardware processors, the second machine learning model component to a remote computing device.

15. The method of claim 15, further comprising:
processing, by the one or more hardware processors, the input data using the first machine learning model component, to generate intermediate neural network output data; and
providing, by the one or more hardware processors, the intermediate neural network output data to the remote computing device.

16. The method of claim 16, further comprising:
receiving, by the one or more hardware processors, second intermediate neural network output data generated at the remote computing device, the second intermediate neural network output data being generated using the second machine learning model component.

17. The method of claim 17, further comprising:
processing, by the one or more hardware processors, the second intermediate neural network output data, using the third machine learning model component, to generate the result data.

18. A non-transitory computer-readable medium comprising instructions that, when executed by one or more hardware processors of a machine, cause the machine to perform operations comprising:
generating a machine learning model comprising a neural network that generates result data based on input data;
splitting, by the one or more hardware processors, the machine learning model into at least a first machine learning model component and a second machine learning model component;
providing the first machine learning model component to a first remote computing device that generates intermediate neural network output data by using the first machine learning model component to process the input data; and
providing the second machine learning model component to a second remote computing device, the second remote computing device generating result data by processing the intermediate neural network output data using the second machine learning model component.

19. A system comprising:
one or more hardware processors; and
a memory storing instructions configured to instruct the one or more hardware processors to perform operations of:
generating a machine learning model comprising a machine learning algorithm that generates result data based on input data;
splitting, by the one or more hardware processors, the machine learning model into at least a first machine learning model component and a second machine learning model component; and
providing the first machine learning model component to a remote computing device associated with an industrial device, wherein the remote computing device is configured to generate intermediate machine learning algorithm output data by using the first machine learning model component to process the input data.
